(19) United States
(12) Patent Application Publication
(10) Pub. No.: US 2007/0105691 A1
(43) Pub. Date: May 10, 2007

(54) Simulated throttle kickdown in automated mechanical transmission

(76) Inventors: Robert A. Sayman, Laurinburg, NC (US); Ronald P. Muetzel, Friedrichshafen (DE); James H. DeVore, Laurinburg, NC (US)

Correspondence Address: BRINKS HOFER GILSON & LIONE, P.O. BOX 10395, CHICAGO, IL, 60610, US

(21) Appl. No.: 11/267,976

(22) Filed: Nov. 7, 2005

(51) Int. Cl. F16H 59/30

(52) U.S. Cl. 477/121

(57) ABSTRACT

Across the spectrum of automatic transmissions, rapidly depressing the accelerator pedal to floor is interpreted by the transmission and associated components as a request for increased engine power to, for example, pass another vehicle or climb a hill. A method of operating an automated mechanical transmission includes a throttle position sensor and electronic control unit and provides a simulated signal in response to various full throttle positions and travel. Various time and position dependent relationships such as substantially fully depressed throttle, rapidly depressed throttle, throttle maintained substantially fully depressed and throttle substantially fully released before being depressed, i.e., a “pumped” throttle are sensed by the throttle position sensor and interpreted as a throttle kickdown by the electronic control unit which generates a kickdown signal.

### BACKGROUND OF THE INVENTION

The invention relates generally to a method of operating an electronic control unit of an automated mechanical transmission and more particularly to a method which simulates and provides a control signal indicating throttle kickdown.

In virtually all vehicles equipped with automatic transmissions, the action by the vehicle operator of depressing the accelerator pedal to the floor is interpreted by either the mechanical or electronic controls of the prime mover and transmission as a “kickdown” or “kickdown shift”: a desire to increase the speed and power of the prime mover and engage a lower gear in order to pass another vehicle or climb a grade. Depending upon the type of vehicle and transmission, such systems typically include mechanical linkages to the fuel or other engine systems and the transmission in the case of full mechanical systems and position sensors or switches wherein control of the engine and transmission are achieved through electronic, i.e., computer and software means in, for example, drive by wire systems.

In the latter case, switches activated by fully or substantially fully depressed accelerator or throttle pedals may be prone to failure but certainly require additional materials, wiring, engineering and design. Elimination of an on/off throttle position sensor therefore represents a reduction in engineering and component costs as well as an improvement in reliability.

### BRIEF SUMMARY OF THE INVENTION

A method of operating an automated mechanical transmission includes a throttle position sensor and electronic control unit including software which provides a simulated signal in response to various full throttle positions and travel. Various time and positioned dependent relationships are sensed by a throttle position sensor and interpreted as a throttle kickdown by the electronic control unit which generates a kickdown signal. For example, in its least complex configuration, sensed travel beyond a predetermined threshold of 90% or 95% of full throttle pedal travel is interpreted as a kickdown request. A second criteria which may be combined with the above approach is to sense the speed of displacement (dT/dt) of the throttle pedal. Displacement speed above a predetermined threshold combined with 90% or 95% throttle displacement will generate a kickdown command. A third criteria is whether the throttle pedal maintains its 90% or 95% (or greater) position for a predetermined time period, e.g. 3, 5 or 10 seconds, or longer. A fourth criteria is whether the throttle pedal has been released such that it is below 10% of full travel and then satisfies other, above-recited criteria.

Thus, it is an object of the present invention to provide a throttle position sensor and software which simulates, by providing an output, when a driver has commanded a kickdown.

It is a still further object of the present invention to provide a sensor and software which simulates a driver kickdown command without utilizing a full travel two position, i.e., on-off sensor.

It is a still further object of the present invention to provide a proportional throttle sensor and electronic control unit which provides a kickdown signal to associated transmission control equipment.

It is a still further object of the present invention to provide a proportional throttle sensor and software which provides a kickdown signal to associated electronic equipment in response to various kickdown actions by the vehicle operator.

Further objects and advantages of the present invention will become apparent by reference to the following description of the preferred embodiment and appended drawings wherein like reference numbers refer to the same components, elements or features.

### BRIEF DESCRIPTION OF THE DRAWINGS

FIG. 1 is a diagrammatic view of a conventional truck engine and transmission illustrating various operators and sensors;

FIG. 2 is a composite figure illustrating various throttle and sensor activity that may be interpreted as a kickdown request by the driver; and

FIG. 3 is a flow chart of software incorporating the present invention.

### DETAILED DESCRIPTION OF THE PREFERRED EMBODIMENT

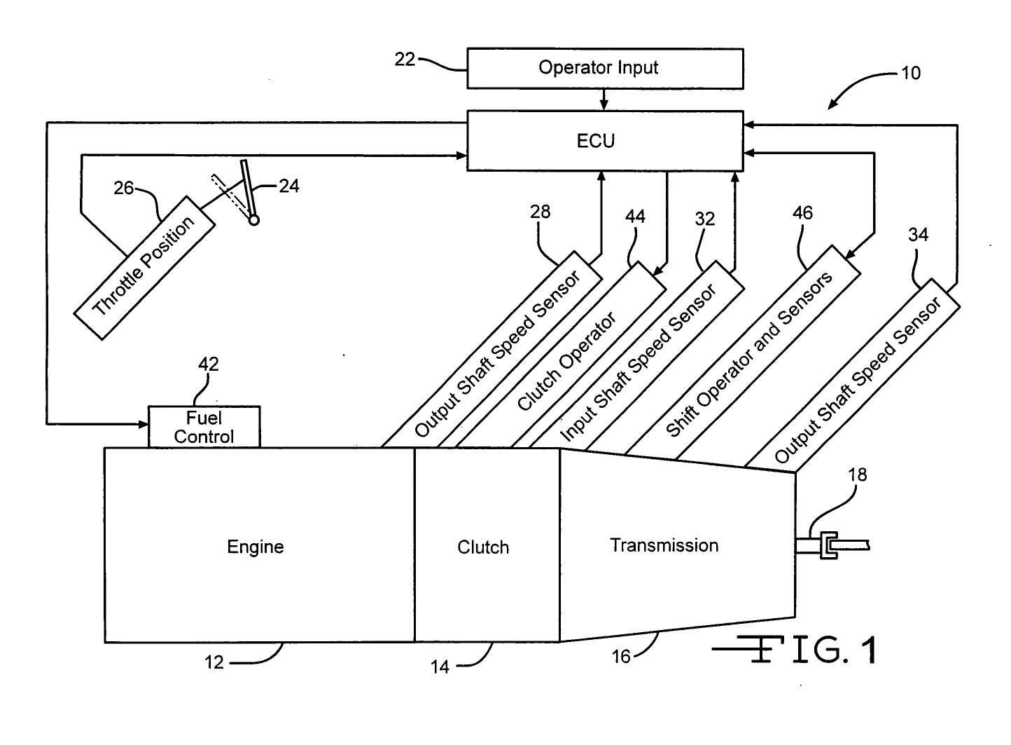

Referring now to FIG. 1, a diagrammatic view of a primer mover and automated mechanical transmission combination is illustrated and generally designated by the reference number 10. The prime mover and automated transmission combination 10 includes an engine such as an internal combustion gas or Diesel engine 12 which is selectively coupled through a master friction clutch 14 to an automated mechanical transmission 16. The automated mechanical transmission 16 typically includes a splitter or two range gear box at the head or input end of the transmission 16, a three or four speed gear box driven by the output of the splitter and a two speed planetary gear assembly which drives an output shaft 18.

The combination 10 also includes a microprocessor or electronic control unit (ECU) 20 which receives signals and data from various controls and sensors and controls the overall operation of the engine 12, the master friction clutch 14 and the various sections of the transmission 16. Specifically, the electronic control unit 20 is provided with data or input from the driver through sensors 22 such as the state of the ignition system, whether the transmission is to operate in automatic or manual mode and, in the latter case, provides commands regarding upshifts and downshifts. Additionally, specific driver input is provided by the throttle or accelerator pedal 24 which is coupled to and translates a linear and proportional or modulating throttle position transducer or sensor 26 which provides real time data to the electronic control unit 20 regarding the current position of the accelerator pedal 24. The output of the sensor 26 may be a variable voltage, or coded signal or any other data stream compatible with and readily detected and read by the electronic control unit 20. The current position signal from the throttle position sensor 26 may also be differentiated in the electronic control unit 20 to provide a speed of motion signal, i.e., derivative signals dT/dt, that is the change of position of the accelerator or throttle pedal 24 per unit of time.

Additionally, the electronic control unit 20 will typically receive a signal from an engine output shaft speed sensor 28 indicating the current rotational speed of the engine output shaft. An input shaft speed sensor 32 provides real time data to the electronic control unit 20 regarding the speed of rotation of the input shaft of the transmission 16. Similarly, a transmission output shaft speed sensor 34 provides real time data regarding the rotational speed of the output shaft 18 of the transmission 16.

Certain aspects and components of the engine 12, clutch 14 and transmission 16 are under control of the electronic control unit 20. For example, a fuel control assembly 42 adjusts the flow of fuel to the engine 12 in accordance with the position of the throttle 24 as indicated by the throttle position sensor 26 as well as various software, subroutines and algorithms which control overall operation of the engine 12, the master friction clutch 14 and the transmission 16. For example, during a gear change, fuel to the engine 12 may be reduced momentarily by the fuel control assembly 42 in order to assist synchronization of the engine output shaft and transmission input shaft in the newly selected gear. A clutch operator 44 receives an output signal from the electronic control unit 20 and engages and disengages the master friction clutch 14. A shift operator and sensor assembly 46 includes a plurality of pneumatic, hydraulic or electric operators and associated linear translation sensors which first of all, engage and disengage various gear ratios in the various sections of the transmission 16 and provide data regarding the positions of such actuators to the electronic control unit 20, respectively.

As noted above, rapid depression of the accelerator pedal 24 of essentially any vehicle equipped with an automatic transmission is interpreted by the transmission and associated components as a desire to rapidly accelerate the vehicle by increasing the speed of the engine 12 and downshifting the transmission 16. The throttle position sensor 26, as noted, provides a real time signal regarding the current position of the accelerator pedal 24. Within the electronic control unit 20, this position may be read as an actual measured distance, may be read and utilized as a percentage of travel from zero to one hundred percent, for example, or may be coded into any numerical or alphabetic data chain which is readily recognized and utilized by other components within the electronic control unit 20 to signify the actual position of the throttle pedal 24.

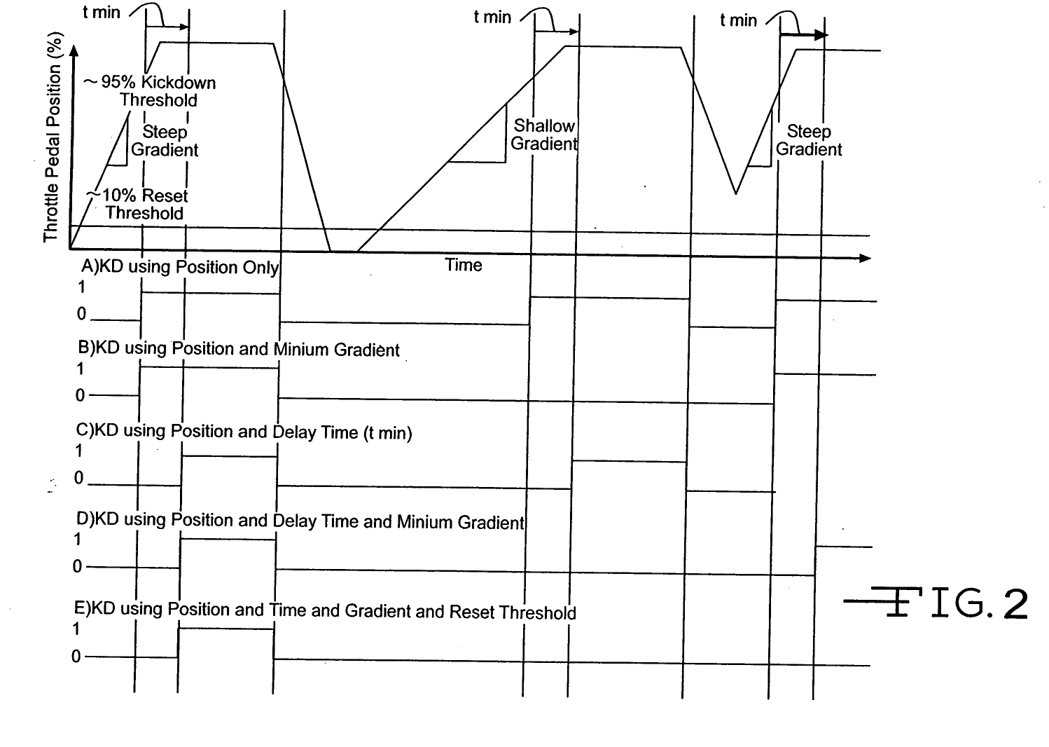

Referring now to FIG. 2, the electronic control unit 20 includes various software and algorithms which receive data regarding the real time position of the accelerator pedal 24 and the sensor 26 and command a downshift and engine acceleration in accordance with various software rules. At the top of FIG. 2, a graph of operator controlled activity of the throttle 24 includes several events which are interpreted by the software as a desire or demand for a kickdown shift. Below the graph of throttle pedal position are five different graphs representing five different sensing and operating modes of the electronic control unit 20 which provide five different responses to the operator activity illustrated at the top of FIG. 2.

Turning first to Graph A, this represents a kickdown signal which is generated solely by full or substantially full displacement of the accelerator or throttle pedal 24. In order to ensure that a kickdown is commanded when the driver so intends, 95% travel of the accelerator pedal 24 and throttle position sensor 26 has been selected as the threshold for a throttle position only kickdown. Clearly, this 95% threshold can be adjusted to, for example 90% to accommodate and achieve slightly different design and operating parameters. Higher values raise the probability that they may not be exceeded due to linkage misadjustment, component wear or foreign objects lodged behind the throttle pedal 24, thus impeding an intended kickdown. Lower values such as below 90% may cause a kickdown signal and associated activity to occur with less throttle travel than is generally desirable. It will be noted that Graph A is in the high or logic 1 position which requests a kickdown only during and always during periods that the position of the throttle 24 exceeds the 95% kickdown threshold.

Given certain vehicle component complements and diverse design and operating goals, it may be desirable to sense operating parameters in addition to just the position of the throttle 24 to affect or control the kickdown decision. Graph B illustrates such a first alternate operating mode. Here, both the 95% kickdown position threshold and speed of motion of the accelerator pedal 24 beyond a predetermined threshold must be satisfied in order for the electronic control unit 20 to generate a kickdown command. To the left in the throttle position graph is a steep gradient which, in combination with the 95% kickdown position threshold causes the electronic control unit 20 to generate a kickdown command as illustrated by the logic diagram which moves from zero or low to one or high when a sufficiently steep throttle position gradient (derivative) and the 95% kickdown position threshold are both exceeded. By way of comparison, note in the middle of the throttle position graph where a shallow gradient coupled with a throttle position exceeding the 95% kickdown threshold does not generate a kickdown signal from the electronic control unit 20.

Another control alternative is illustrated in Graph C where the 95% accelerator pedal kickdown position threshold is combined with a timer or delay function which senses how long the accelerator pedal 24 has been depressed beyond the kickdown position threshold. The time tₘᵢₙ is a short interval of time such as 2, 3, 5, 8, 10, 12 or 15 seconds or more or less which may be empirically or experimentally chosen and during which the accelerator pedal 24 must be maintained beyond the kickdown threshold in order to generate a kickdown signal. When the kickdown position threshold has been exceeded for a predetermined time, i.e., 3, 5 or 10 second timer has timed out, a kickdown signal is generated by the electronic control unit 20.

It is also possible to combine the position, gradient (derivative) and timer or delay functions. This is represented in Graph D of FIG. 2. Note that only the activity on the left side of the throttle position graph which includes a steep gradient or derivative, a final position exceeding the kickdown threshold and maintaining the throttle position beyond the kickdown position threshold for the minimum or reference time tₘᵢₙ commands a kickdown shift.

A final Graph E presents an operating condition wherein the three requirements of curve D, throttle position beyond the threshold, gradient or derivative greater than a reference value throttle position beyond the threshold exceeding a reference or predetermined time period are combined with a reset threshold. The reset threshold senses whether the accelerator pedal 26 has been fully or substantially fully released and is, at least momentarily, in a substantially undepressed or unactivated state. Once again for purposes of ensuring good data, the reset threshold is not set at 0% travel but is a value between 5 and 15% and preferably about 10%. Thus, only when the throttle pedal 24 has been released or substantially released and then followed by a gradient or derivative beyond the threshold, a final position beyond the kickdown threshold and a final position beyond the kickdown threshold which is maintained at least for the minimum time period will a kickdown signal be generated by the electronic control unit.

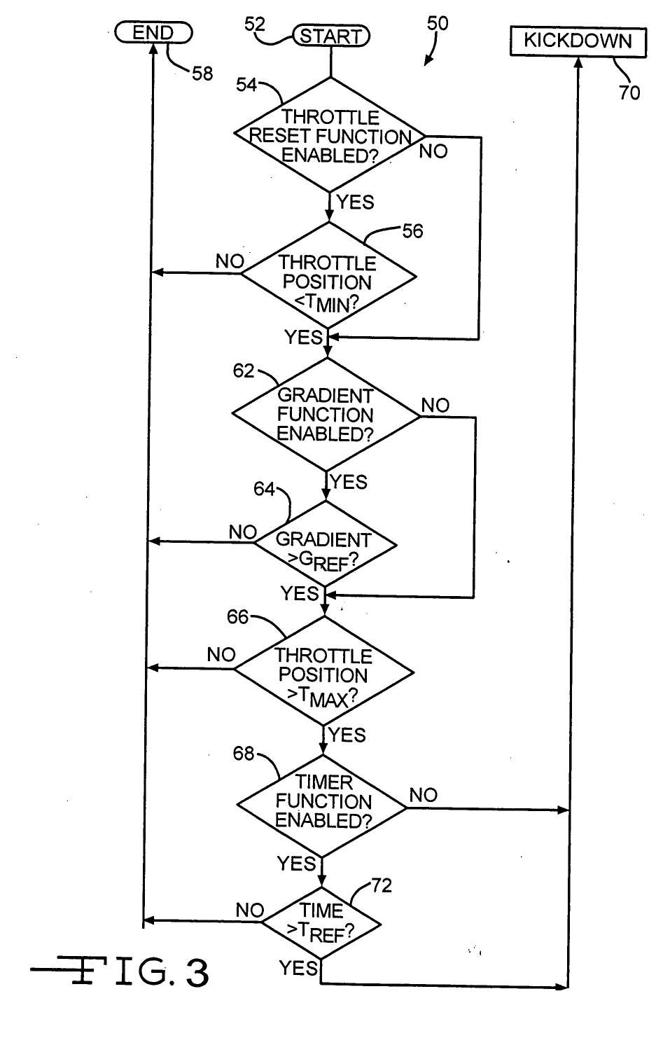

Referring now to FIG. 3, a computer program or software flow chart illustrating a subroutine for the various operating modes or configurations presented in FIG. 2 is illustrated in FIG. 3. The software subroutine 50 starts with an initializing step 52 which clears all registers and commences the iterative cycle of the subroutine 50 anew. A first decision point 54 inquires whether the throttle reset function is enabled. This is the additional step appearing in Graph E at the bottom of FIG. 2. If the throttle reset function is enabled, the decision point 54 is exited at YES and the program 50 moves to a second decision point 56 which inquires whether the throttle position has fallen below a minimum position such as the 10% threshold illustrated in Graph E of FIG. 2. If the throttle position has not been below the minimum or reset position during this cycle, the decision point 56 is exited at NO and the program 50 concludes at an end point 58 to be repeated in accordance with the iteration time commanded by the executive system of the electronic control unit 50.

Returning to the decision point 54, if the throttle reset function has not been enabled, which applies to Graphs A, B, C and D, the decision point 54 is exited at NO and the program moves to a decision point 62. Likewise, if the throttle position has fallen below the minimum throttle position, the decision point 56 is exited at YES. In both instances, the program 50 enters a decision point 62 which inquires whether the gradient function is enabled. This function appears in the Graphs B and D. If the gradient function is enabled, the program moves to a decision point 64 which inquires whether the gradient or derivative dT/dt is greater than the gradient or derivative reference value. If it is not, the decision point 64 is exited at NO and the program 50 returns to its end point 58. If the gradient or derivative is larger than the reference value, the decision point 64 is exited YES and the program 50 moves to a decision point 66. Similarly, if the gradient function is not enabled, the decision point 62 is exited at NO and the program 50 also moves to the decision point 66.

The decision point 66 inquires whether the throttle position has exceeded the maximum throttle value, 95% of the throttle travel as illustrated in FIG. 2. Note that there is no throttle position enabled inquiry because each and every simulated kickdown operational mode illustrated in FIG. 2 utilizes and senses actual throttle position. Thus, if throttle position has not exceeded the 95% threshold, the decision point 66 is exited at NO and the program ends at the end point 58. If the throttle position has exceeded the maximum or threshold value, the decision point 66 is exited at YES and the program 50 enters a decision point 68 which inquires whether the timer or delayed time function is enabled. If it is not, the decision point 68 is exited at NO and the program 50 issues a kickdown command in the process step 70. If the timer function is enabled, the decision point 68 is exited at YES and the program 50 moves to a decision point 72 that inquires whether the time the accelerator pedal 24 has exceeded the kickdown threshold is greater than the delay or reference time. If it is not, the decision point 72 is exited at NO and the program ends at step 58. If the time is greater than the reference time, a decision point 72 is exited at YES and a kickdown signal is generated at step 70.

The entire process in the program 50 is illustrated in Graph E. If the throttle reset function is not enabled, the gradient function is not enabled and the throttle position and timer function are utilized, the operation is presented in Graph C. If the throttle reset function is not enabled but the gradient function and the throttle position are utilized, this is represented by Graph B. If the throttle reset function and the gradient function are not enabled but the throttle position is utilized with the enabled timer function, this operational mode is presented in Graph C. If all of the optional functions are disabled, that is, the throttle reset function, the gradient function and the timer function, the throttle position exceeding the kickdown threshold generates a kickdown signal and this is presented in Graph A.

Upon the generation of a kickdown signal or command by satisfying one of the sets of conditions presented in Graphs A, B, C, D or E of FIG. 2, the electronic control unit 20 will typically proceed to command and execute a one, two or more gear downshift by issuing appropriate commands to the fuel control 42, the clutch operator 44 and the shift operator and sensor assembly 46 in accordance with its established programs and subroutines. It will be appreciated that these programs and subroutines may be the same or similar to programs and subroutines previously utilized with a prior art mechanical switch activated by full throttle depression.

It will also be appreciated that an electronically generated or simulated kickdown signal or command for an automated mechanical transmission provides numerous benefits. First of all, this configuration eliminates a mechanically actuated switch which may be prone to failure. More importantly, however, the data from the throttle position sensor 26 may be utilized through the electronic control unit 20 to institute or command downshifts based upon several operating conditions as well as diverse values of such operating conditions as illustrated in FIG. 2.

The foregoing disclosure is the best mode devised by the inventor for practicing this invention. It is apparent, however, that methods incorporating modifications and variations will be obvious to one skilled in the art of motor vehicle clutches and lubrication thereof. Inasmuch as the foregoing disclosure is intended to enable one skilled in the pertinent art to practice the instant invention, it should not be construed to be limited thereby but should be construed to include such aforementioned obvious variations and be limited only by the spirit and scope of the following claims.

1. A method of providing a throttle kickdown signal for an automated mechanical transmission comprising the steps of:
providing a throttle position sensor having an output;
providing an electronic controller having an input for receiving said sensor output and an output for a kickdown signal;
determining when said throttle position sensor exceeds a predetermined threshold,
providing said kickdown signal when said predetermined threshold is exceeded.

2. The method of claim 1 further including the step of determining the rate of change of said throttle position sensor and providing a kickdown signal only when said rate exceeds a predetermined rate and said throttle position sensor exceeds a predetermined threshold.

3. The method of claim 1 further including the step of providing a timer for determining a period of time said throttle position sensor exceeds said predetermined threshold and providing a kickdown signal only when said throttle position sensor exceeds a predetermined threshold and said period of time exceeds a predetermined time.

4. The method of claim 1 further including the step of sensing when said throttle position sensor is below a predetermined minimum value.

5. The method of claim 1 wherein said throttle position sensor is a linear transducer.

6. The method of claim 1 wherein said predetermined threshold is at least 90% of throttle travel.

7. The method of claim 1 further including the step of providing a throttle pedal linked to said throttle position sensor.

8. A method of providing an indication of a throttle kickdown, comprising the steps of:
sensing a real time position of a throttle pedal and providing a kickdown indication when
the throttle pedal is depressed at least 90% of its full travel; and
at least one condition selected from the following group of conditions exists:
the throttle pedal was previously released to less than 10% of its full travel;
the throttle pedal is depressed at a rate faster than a predetermined rate; and
the throttle pedal remains depressed at at least 90% of its full travel for longer than a predetermined time.

9. The method of claim 8 wherein said throttle pedal sensing is achieved by a linear transducer.

10. The method of claim 8 wherein said predetermined time is between 3 and 10 seconds.

11. The method of claim 8 further including the step of providing an electronic control unit for providing said kickdown indication.

12. The method of claim 8 wherein at least two of said following conditions exist.

13. The method of claim 8 wherein all of said following conditions exist.

14. The method of claim 8 wherein said kickdown indication causes a downshift of at least one gear ratio.

15. A method of generating a simulated kickdown signal for an automated mechanical transmission, comprising the steps of:
providing a throttle position transducer having an output;
providing said output to an input of a an electronic control unit which generates a kickdown signal when
the throttle position exceeds a predetermined maximum value; and
at least one of the following conditions is true:
a) the throttle position was previously less than a predetermined minimum value;
b) the rate of change of the throttle position is greater than a predetermined rate; and
c) the throttle position exceeds the predetermined maximum value for longer than a predetermined time.

16. The method of claim 15 wherein said predetermined maximum value is 90%.

17. The method of claim 15 wherein said predetermined minimum value is 10%.

18. The method of claim 15 wherein said predetermined time is between 3 and 15 seconds.

19. The method of claim 15 wherein at least two of said conditions are true.

20. The method of claim 15 wherein all of said conditions are true.
